(19) United States
(12) Patent Application Publication
(10) Pub. No.: US 2017/0278463 A1
(43) Pub. Date: Sep. 28, 2017

(54) DISPLAY SYSTEM, DISPLAY CONTROL DEVICE, DISPLAY CONTROL METHOD, AND PROGRAM

(71) Applicant: NEC Corporation, Tokyo (JP)

(72) Inventor: Kenichiro FUJII, Tokyo (JP)

(21) Appl. No.: 15/512,359

(22) PCT Filed: Sep. 16, 2015
(86) PCT No.: PCT/JP2015/076255

§ 371 Date: Mar. 17, 2017

(30) Foreign Application Priority Data
Sep. 19, 2014 (JP) 2014-191435

(51) Int. Cl. G09G 3/34

(52) U.S. Cl. CPC G09G 3/344; G09G 2320/02; G09G 2340/16

(57) ABSTRACT

A display system includes: a display control device that inserts prescribed image data for lessening degradation of image quality in a middle of source data; and a display device that displays an image generated based on the source data and an image generated based on the prescribed image data.

### TECHNICAL FIELD

The present invention relates to a display system, a display control device, a display control method, and a program.

### BACKGROUND ART

There is electrophoretic electronic paper that generates an image by causing electrophoretic particles to move within a capsule that is disposed between two electrodes. In this electronic paper, when repeatedly rewriting an image, a phenomenon occurs in which an image that was displayed in the past is displayed as an afterimage. For that reason, the afterimage is generally eliminated by performing an operation called a “refresh” that once darkens the entire display screen. Afterward, a voltage corresponding to the image to be displayed after rewriting is impressed on the two electrodes.

Patent Document 1 discloses a technique to display text so as to reduce the difference between the gradation of text and the gradation of the background of the text depending on the scrolling speed of a screen of the display unit.

Patent Document 2 discloses as related art a technique that suppresses degradation in the image quality of a display unit by utilizing the time required for determining a user's operation content, such as a long press.

### PRIOR ART DOCUMENTS

### Patent Documents

[Patent Document 1] Japanese Unexamined Patent Application. First Publication No. 2014-130577

[Patent Document 2] Japanese Unexamined Patent Application. First Publication No. 2010-45527

### SUMMARY OF THE INVENTION

### Problem to be Solved by the Invention

Generally in an electrophoretic display unit, the refresh operation that lessens degradation of the display such as an afterimage is performed by applying a predetermined potential to the display system. For a refresh operation that the display system performs, the user is able to set a condition such as performing the refresh operation for example “every four pages”. The display system performs the refresh operation in the case of the condition set by the user being satisfied. However, in the case of using electrophoretic electronic paper to display a display that changes at high speed, such as moving image data, when the display system performs a refresh operation for example “every four pages”, the refresh operation is performed every four frames of the display that changes at high speed. As a result, the smooth transition of images is impeded. For that reason, technology has been sought whereby a display device can cleanly display an image when displaying an image that changes at high speed.

One exemplary object of this invention is to provide a display system, a display control device, a display control method, and a program that can solve the aforementioned issue.

### Means for Solving the Problem

A display system according an exemplary aspect of the present invention includes: a display control device that inserts prescribed image data for lessening degradation of image quality in a middle of source data to generate post-insertion image data; and a display device that displays an image based on the post-insertion image data.

A display control device according to an exemplary aspect of the present invention includes: an insertion unit that inserts prescribed image data for lessening degradation of a display in a middle of source data.

A display control method according to an exemplary aspect of the present invention includes: inserting prescribed image data for lessening degradation of image quality in a middle of source data.

A program according to an exemplary aspect of the present invention causes a computer of a display control device to execute: inserting prescribed image data for lessening degradation of image quality in a middle of source data.

### Effect of the Invention

According to an exemplary embodiment of the present invention, a display device that performs an operation of lessening the degradation of a display that occurs due to display change can cleanly display an image when displaying an image that changes at high speed.

### BRIEF DESCRIPTION OF THE DRAWINGS

FIG. 1 is a block diagram that shows an example of the constitution of a display control device according to an exemplary embodiment of the present invention.

FIG. 2 is a block diagram that shows an example of the constitution of a display system according to a first exemplary embodiment of the present invention.

FIG. 3A is an explanatory diagram that shows an example of an image data insertion unit according to the first exemplary embodiment of the present invention inserting prescribed image data in the middle of source data.

FIG. 3B is an explanatory diagram that shows an example of the image data insertion unit according to the first exemplary embodiment of the present invention inserting prescribed image data in the middle of source data.

FIG. 4 is a diagram that shows an example of the process flow of the display system according to the first exemplary embodiment of the present invention.

FIG. 5A is a diagram that shows an example of an image data insertion unit according to a second exemplary embodiment of the present invention inserting prescribed image data in the middle of source data when magnifying an image.

FIG. 5B is a diagram that shows an example of the image data insertion unit according to the second exemplary embodiment of the present invention inserting prescribed image data in the middle of source data when magnifying an image.

FIG. 6 is a diagram that shows an example of the process flow of the display system according to the second exemplary embodiment of the present invention.

### EXEMPLARY EMBODIMENTS FOR CARRYING OUT THE INVENTION

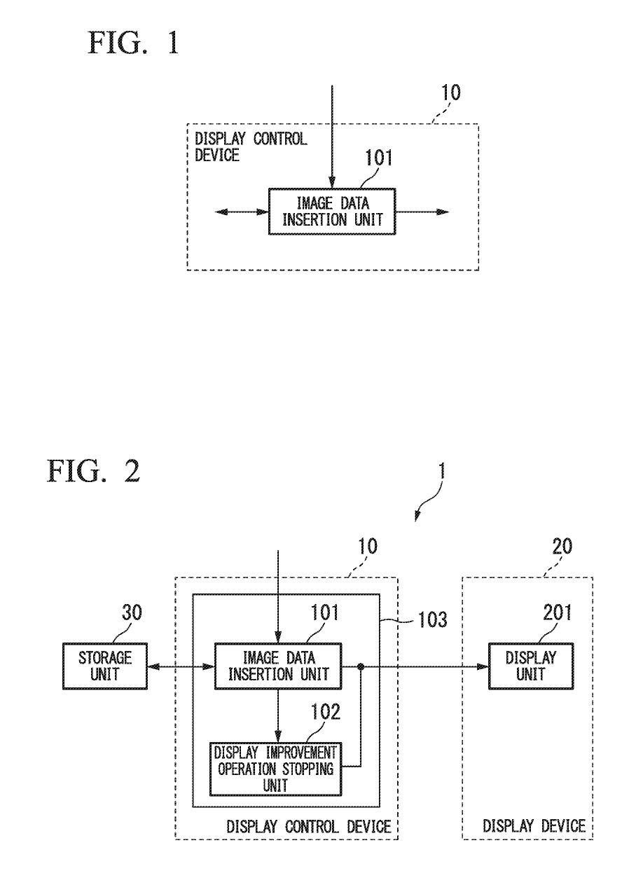

FIG. 1 is a block diagram that shows an example of the constitution of a display control device 10 according to an exemplary embodiment of the present invention.

The display control device 10 includes at least an image data insertion unit 101 as shown in FIG. 1.

The image data insertion unit 101 inserts prescribed image data for lessening degradation of the display produced by a display change in the middle of the source data.

### First Exemplary Embodiment

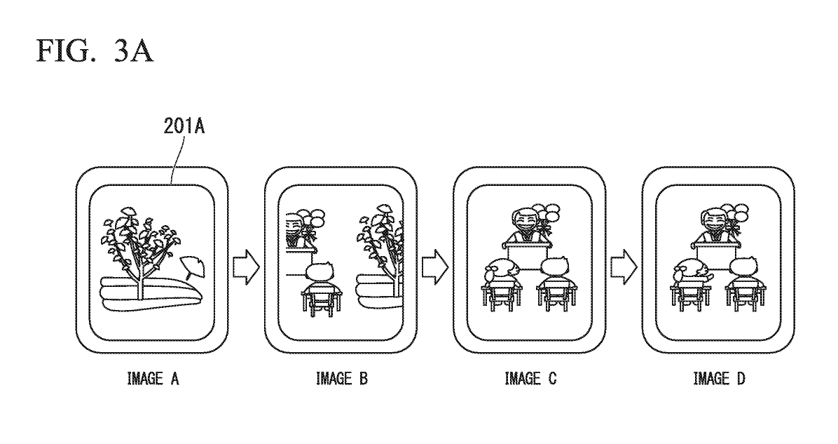

FIG. 2 is a block diagram showing an example of the constitution of the display system 1 according to the first exemplary embodiment of the present invention.

As shown in FIG. 2, the display system 1 according to the first exemplary embodiment is provided with the display control device 10, a display device 20, and a storage unit 30.

The display control device 10 includes a display control unit 103 including an insertion unit 101 and a display improvement operation stopping unit 102. The image data insertion unit 101 is sometimes simply called the insertion unit 101 hereinbelow. The display improvement operation stopping unit 102 is sometimes simply called the stopping unit 102 hereinbelow. The insertion unit 101 shown in FIG. 2 may have the same constitution as the insertion unit 101 shown in FIG. 1.

The insertion unit 101 inserts, in the middle of the source data, prescribed image data for lessening the degradation of the display (image quality) produced by changing the display (image). More specifically, the insertion unit 101 judges whether the differential of continuous data included in source data such as a moving image, in which the display changes at high speed, is equal to or less than a prescribed threshold value. When the insertion unit 101 has judged that the differential of the data is equal to or less than the prescribed threshold value, it inserts a prescribed image data for lessening the degradation of the display produced by a display change immediately before the continuous data. The prescribed image data may for example be image data that displays a monochrome image such as a black image, a white image, or the like in the entire screen of the display device 20.

Specific examples of the differential of continuous data included in source data include a time-series differential, a differential between adjacent pixels, a differential based on luminance, a differential based on contrast, a differential based on gradation, a differential based on hue, a differential based on brightness, and a differential based on saturation. That is, the data differential many include a time-series differential of two continuous image data sets included in the source data. The data differential may include the differential between a differential between data displayed in adjacent pixels included in one image data among two continuous image data sets, and a differential between data displayed in adjacent pixels included in another image data. The data differential may include a differential in luminance of two continuous image data sets. The data differential may include the differential in contrast of two continuous image data sets. The data differential may include the differential in gradation of two continuous image data sets. The data differential may include the differential in hue of two continuous image data sets. The data differential may include the differential in brightness of two continuous image data sets. The data differential may include the differential in saturation of two continuous image data sets. The prescribed threshold value indicates a threshold value for determining whether or not continuous image data included in moving image data is data that represents a still image (or a moving image approximating a still image with little change). The case of continuous image data included in moving image data being data that represents a still image may include the case of the same image continuing for a prescribed time (for example, 1 sec.). The prescribed threshold value may also indicate a threshold value for determining whether or not continuous image included in moving image data is data constituting a moving image with little change (a moving image approximating a still image).

The image displayed by the display device 20 according to the first exemplary embodiment of the present invention is not limited to a monochrome image. For example, the display device 20 may display a color image by a method that uses a color filter, a method that applies color to particles themselves and divides them into pixels, and a method that puts particles of three or more colors in one pixel.

The display control unit 103 may also instruct the display device 20 to perform a refresh operation that once darkens the entire display screen of the display device 20. The display device 20 may perform the refresh operation in accordance with an instruction from the display control unit 103. This refresh operation is one example of an improvement operation that lessens degradation of the image quality produced by changing the image displayed by the display device 20. The refresh operation differs from the operation that inserts prescribed image data for lessening degradation of the image quality in the middle of the source data (insertion operation).

The stopping unit 102 stops the operation of lessening degradation of the display that is performed not based on data for displaying an image generated by the insertion unit 101 inserting prescribed image data in the middle of source data. For example, the stopping unit 102 stops the aforementioned refresh operation performed by the display control unit 103, which is performed not based on data for displaying an image generated by the insertion unit 101 inserting prescribed image data showing a monochromatic image in the middle of the source data (hereinbelow, image data after data insertion (post-insertion image data)). That is, the display control unit 103 instructs the display device 20 to stop the refresh operation (improvement operation).

The display control unit 103 causes the display device 20 to display an image represented by the image data after data insertion by the insertion unit 101.

A portion or all portions of the display control device 10 may operate on the basis of a dedicated application program.

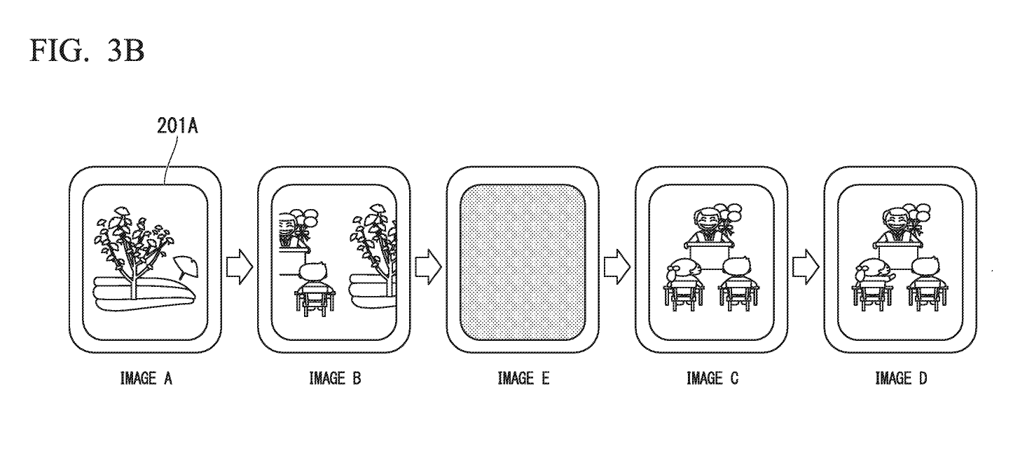

The display device 20 includes a display unit 201 having a display screen 201A (refer to FIG. 3A).

The display unit 201 displays an image on the basis of control by the display control unit 103. The display unit 201 may for example be a display unit of the electrophoretic display system or the particle movement system. The display unit 201 performs the operation of lessening degradation of the display that occurs from display change. Hereinbelow, as a specific example, a description will be given for the case of the display unit 201 being a display unit of the electrophoretic display system that performs the operation of lessening degradation of the display that occurs from display change and performs display control using electrophoretic elements. The image (moving image) displayed by the display unit 201 is not limited to a monochromatic image (moving image). The display unit 201 may display a color image (moving image) by a method that uses a color filter, a method that applies color to particles themselves and divides them into pixels, and a method that puts particles of three or more colors in one pixel.

The storage unit 30 stores various data required for the processes performed by the display system 1.

FIGS. 3A and 3B are explanatory diagrams showing examples in which the insertion unit 101 according to the first exemplary embodiment of the present invention inserts prescribed image data in the middle of the source data.

FIG. 3A shows the image (moving image) based on source data before inserting prescribed image data. FIG. 3A shows the image (moving image) based on the image data after inserting the prescribed image data. As shown in FIGS. 3A and 3B, the display screen 201A of the display unit 201 displays various images. In the source data shown in FIG. 3A, the images from an image prior to image A in time series to the image A, and the image C and image D constitute still images or moving images approximating still images with little change. In the source data shown in FIG. 3A, image B is an image in the middle of the transition of the display from image A to image C, and is an image with a lot of change (an image that constitutes a portion of a moving image with numerous changes). Also, the source data shown in FIG. 3A includes moving image data in which the display transitions from image A to image C at each predetermined time interval. In order to simplify the description, in the example shown in FIG. 3A, only one image is shown as image B, but a plurality of images may exist before and after image B. That is, a plurality of images may exist between image A and image B, and a plurality of images may exist between image C and image D. In image C and image D, the position of the girl's right hand differs. However, it may not be limited to such a case, and image C and image D may be the same image (that is, image C may be continuously displayed for a predetermined time or more).

Human eyes have a characteristic of showing high sensitivity to changes in a still image. For this reason, when displaying in the display unit 201 moving image data in which the display transitions from image A to image C, the display control unit 103 needs to cleanly display image A and image C, which approximate a still image. On the other hand, human eyes have a characteristic of showing low sensitivity to changes in a moving image. For this reason, the display control unit 103 does not need to display so cleanly the image B, in which changes are numerous, in the middle of the transition of the display from image A to image C.

However, when the display unit 201 displays the image B in which there are many changes, degradation of the display such as an afterimage occurs. Therefore, the insertion unit 101 compares the image data of two images displayed in succession in the display unit 201, and specifies the differential of the two image data sets. In the example shown in FIG. 3A, the insertion unit 101 compares the image data of the image immediately before image A and the image data of image A, which are included in the moving image data, and specifies that the differential of these two image data sets is less than the threshold value. The insertion unit 101 compares the image A and the image immediately after image A included in the moving image data, and specifies that the differential of these two image data sets is greater than the threshold value. The image immediately after image A may be image B. The insertion unit 101 compares the image data of image C and the image data of the image immediately after image C, and specifies that the differential of these two image data sets is less than the threshold value. The image immediately after image C may be image D. The insertion unit 101 compares the image data of image B and the image data of the image immediately after B, and specifies that the differential of these two image data sets is greater than the threshold value. The image immediately after image B may be image C.

That is, the insertion unit 101 compares the image data of two images to specify each differential of the two image data sets, and determines whether or not each specified differential is equal to or less than the prescribed threshold value. A prescribed threshold value may show a threshold value that determines whether or not continuous image data included in moving image data is data that represents a still image (or a moving image approximating a still image).

In the case of the insertion unit 101 having determined that the specified differential is equal to or less than the prescribed threshold value, it determines the two image data sets to be data constituting a still image (or a moving image approximating a still image). Then, the insertion unit 101 inserts prescribed image data immediately before the initial image data of the two image data sets. In the case of the example shown in FIG. 3A, the insertion unit 101 compares the differential of the image data of image C and the image data of image D (the image immediately after image C) included in the moving image data with a prescribed threshold value. The insertion unit 101 determines that the differential of image C and image D is equal to or less than the prescribed threshold value, and therefore determines image C and image D to constitute a moving image approximating a still image. Then, as shown in FIG. 3B, the insertion unit 101 inserts image data of the image E that shows a black image (indicated by the hatching in FIG. 3B) as prescribed image data immediately before the data showing the image C in the source data. Then, the insertion unit 101 outputs the image data after data insertion to the display control unit 103.

Moreover, the stopping unit 102 stops the improvement operation that lessens degradation of the display performed by the insertion unit 101 not based on the image data after data insertion. That is, in response to the insertion unit 101 inserting prescribed image data in source data, the stopping unit 102 stops the improvement operation.

If performed in this manner, the display system 1 can cleanly display an image approximating a still image in a moving image, when displaying in the display unit 201 a display that changes at high speed by displaying moving image data in which prescribed image data has been inserted.

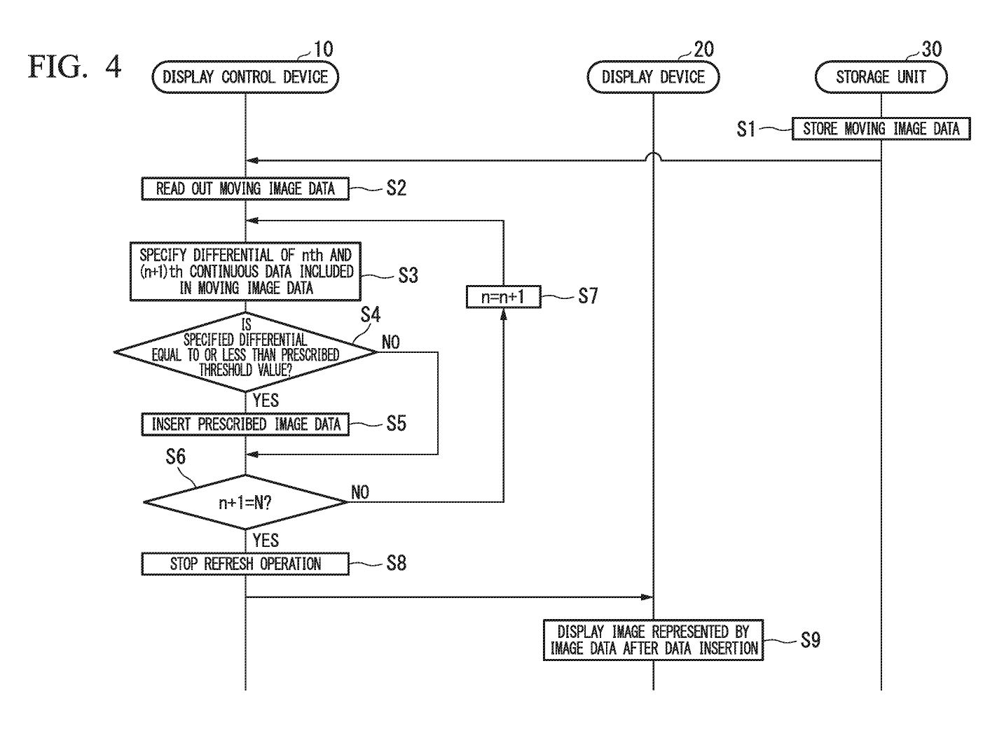

FIG. 4 shows one example of the process flow of the display system 1 according to the first exemplary embodiment.

Next, the process performed by the display system 1 of the first exemplary embodiment will be explained.

As a specific example, the process performed by the display system 1 will be explained in the case of the data that the display system 1 handles being moving image data.

The user accesses a website using a device such as the display system 1, and downloads moving image data from the website. The storage unit 30 that the display system 1 includes stores the moving image data downloaded by a user operation (Step S1).

The insertion unit 101 reads moving image data from the storage unit 30 (Step S2).

The insertion unit 101 specifies a differential of nth and (n+1)th continuous data included in the moving image data read from the storage unit 30 (Step S3). For example, the insertion unit 101 performs the following process assuming the initial value of n=1 (image data of n=1 indicates the first image data included in moving image data). That is, the insertion unit 101 compares the time-series luminance, contrast, gradation, hue, brightness, saturation and the like of nth image data and (n+1)th image data that are two continuous image data sets, and specifies a differential on the basis of the comparison result. For example, the insertion unit 101 may compare the luminance, contrast, gradation, hue, brightness, saturation and the like between adjacent pixels of nth and (n+1)th image data, and specify the differential based on the comparison result. The insertion portion 101 may also specify the differential of two continuous image data sets included in moving image data as a differential based on any one of luminance, contrast, gradation, hue, brightness, saturation and the like. The insertion unit 101 may also specify the differential of two continuous image data sets included in moving image data as a differential based on a combination of any two or more among luminance, contrast, gradation, hue, brightness, saturation and the like. The information that the insertion unit 101 uses when specifying the differential of two image data sets is not limited to luminance, contrast, gradation, hue, brightness, and saturation. The insertion unit 101 may use any kind of information provided it is information that can suitably determine the differential of two image data sets.

The insertion unit 101 compares the specified differential and prescribed threshold value. The insertion unit 101 determines whether or not the specified differential is equal to or less than the prescribed threshold value (Step S4).

When the insertion unit 101 determines that the specified differential is equal to or less than the prescribed threshold value (YES in Step S4), it determines that the two image data sets are data constituting a moving image approximating a still image. Then, the insertion unit 101 inserts prescribed image data immediately before the first image data of the two image data sets (Step S5). In the case of the example shown in FIG. 3A, the insertion unit 101 compares the differential of the image data of image C and the image data of image D (the image immediately following image C) included in moving image data with the threshold value. In the case of having determined that the differential of the image data of image C and image D is equal to or less than the threshold value, the insertion unit 101 determines the image data of image C and image D to be data constituting a moving image approximating a still image. Then, the insertion unit 101 inserts for example prescribed image data constituting the image E representing a black image (refer to FIG. 3B) immediately before the data showing the image C of the source data.

Only in the case of the first time of the process of inserting prescribed image data immediately before the first image data of the two image data sets, the insertion unit 101 outputs to the stopping unit 102 a data insertion notification signal indicating that it has inserted the prescribed image data.

In the case of having determined that the specified differential is not equal to or less than the threshold value (NO in Step S4), the insertion unit 101 determines the two image data sets not to be data constituting a moving image approximating a still image. Then, the insertion unit 101 determines whether or not the (n+1)th image data included in the moving image data is the last (Nth) image data included in the moving image data without performing the process of Step S5 (Step S6). For example, the insertion unit 101 compares the number n+1 indicated by the (n+1)th image data in the two image data sets subjected to the determination process and the number N indicated by the Nth image data, which is the last image data included in the moving image data. In the case of “n+1” and “N” being equal, the insertion unit 101 determines the (n+1)th image data included in the moving image data to be the last image data included in the moving image data.

In the case of having determined that the (n+1)th image data included in the moving image data is not the last image data included in the moving image data (NO in Step S6), the insertion unit 101 adds “1” to “n” for advancing by 1 the pairing of two image data sets subjected to the determination process (Step S7). Then, the process returns to Step S3.

When the insertion unit 101 has determined the (n+1)th image data included in the moving image data to be the last image data included in the moving image data (YES in Step S6), the insertion unit 101 outputs the image data after data insertion to the display control unit 103.

The stopping unit 102, upon receiving the data insertion notification signal output from the insertion unit 101, stops the operation of lessening degradation of the display that is performed without being based on the image data after data insertion (Step S8). For example, the stopping unit 102, upon receiving image data after data insertion from the insertion unit 101, stops the refresh operation performed by the display control unit 103. The display control unit 103 then instructs the display device 20 to display the moving image represented by the image data after data insertion.

The display unit 201 that the display device 20 includes displays the moving image (image) represented by the image data after data insertion on the basis of control by the display control unit 103 that the display control device 10 includes (Step S9).

This concludes the description of the process flow of the display system 1 according to the first exemplary embodiment of the present invention.

In the process of the aforementioned display system 1, the insertion unit 101 inserts prescribed image data for lessening degradation of the display, which occurs from display change, in the middle of the source data. The stopping unit 102 stops the operation of lessening degradation of the display occurring from display change which is performed without being based on the image data after data insertion by the insertion unit 1. More specifically, for example the stopping unit 102 stops the refresh operation performed by the display control unit 103, which is performed without being based on the image data after data insertion by the insertion unit 101. The display unit 103 causes the display device 20 to display the moving image represented by the image data after data insertion.

By this means, in the display unit 201, the display device 20, in which an operation is performed that lessens degradation of the display that occurs from display change, can cleanly display a display when displaying a display that approximates a still image in moving image data that changes at high speed.

The process of the display system 1 is not limited to the process shown in FIG. 4. A portion of the process shown in FIG. 4 (steps S3 to S5) may be the following process. That is, the insertion unit 101 compares the differential between an nth image data and an (n+1)th image data, which are two continuous image data sets, and a prescribed threshold value. Also, the insertion unit 101 compares the differential between an (n+1)th image data and an (n+2)th image data, which are two continuous image data sets, and a prescribed threshold value. In the case of having judged that the differential between the nth image data and the (n+1)th image data is not equal to or less than the prescribed threshold value, and that the differential between the (n+1)th image data and the (n+2)th image data is equal to or less than the prescribed threshold value, the insertion unit 101 inserts prescribed image data immediately before the (n+)th image data (that is, immediately after the nth image data).

### Second Exemplary Embodiment

Next, a display system 1 according to a second exemplary embodiment will be described.

The constitution of the display system 1 according to the second exemplary embodiment of the present invention is the same as the constitution of the display system 1 according to the first exemplary embodiment shown in FIG. 2. The point of difference between the first exemplary embodiment and the second exemplary embodiment is the point that the data handled by the display system 1 according to the second exemplary embodiment is image data used when magnifying an image.

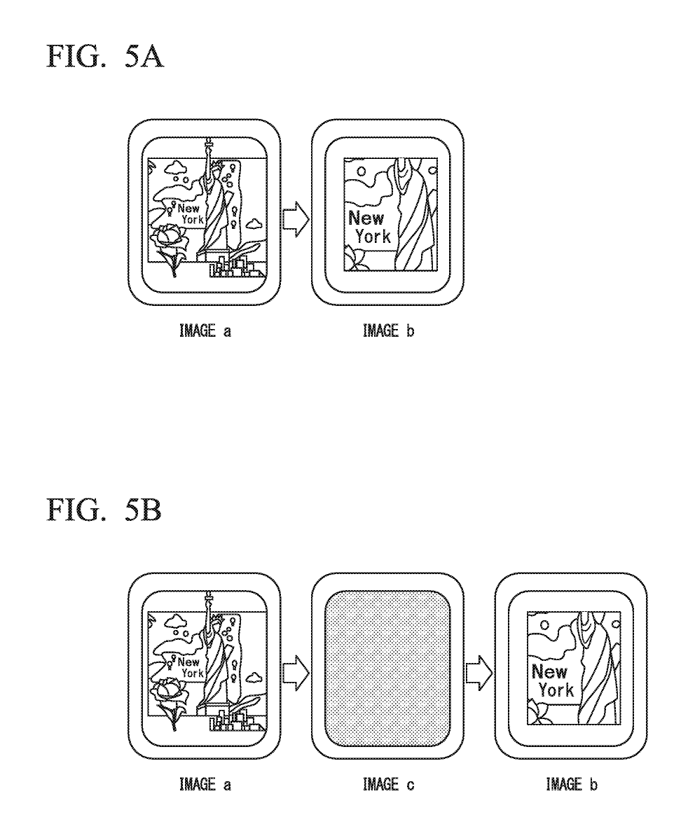

FIGS. 5A and 5B are diagrams that show examples of the insertion unit 101 according to the second exemplary embodiment of the present invention inserting prescribed image data in the middle of source data when magnifying an image.

FIG. 5A is a diagram that shows magnification of an image prior to insertion of prescribed image data. FIG. 5B is a diagram that shows magnification of an image after insertion of prescribed image data.

In the source data shown in FIG. 5A, image b is a magnified image of a portion of image a.

When magnifying image a in response to an operation such as a pinch out by the user, the display unit 201 displays an image of a scale factor in accordance with that operation. In that case, the display of the display unit 201 transitions from display of an image to display of a moving image.

For that reason, in the case of the display unit 201 displaying a moving image that transitions from an image a that is a still image to an image b that is a still image in response to a magnification operation by the user, similarly to the case described referring to FIGS. 3A and 3B, the insertion unit 101 inserts prescribed image data immediately before the image data that constitutes image b. As shown in FIG. 5B, the prescribed image data may be image data that constitutes image c showing for example a black image (displayed by hatching in FIG. 5B).

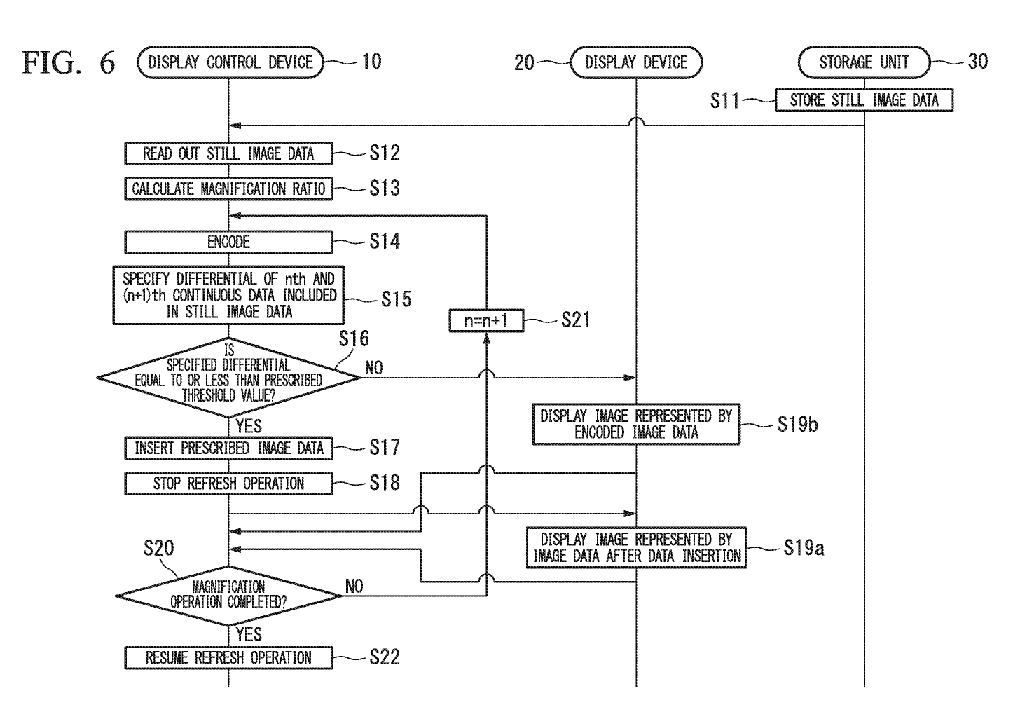

FIG. 6 is a diagram that shows an example of the process flow of the display system 1 according to the second exemplary embodiment of the present invention.

Next, the process performed by the display system 1 according to the second exemplary embodiment will be described.

Note that here will be described the process that the display system 1 performs when displaying a magnification of a still image displayed by a magnification operation by the user.

The storage unit 30 that the display system 1 includes stores still image data in accordance with a user operation (Step S11).

The insertion unit 101 reads still image data from the storage unit 30 (Step S12). When the insertion unit 101 reads still image data from the storage unit 30, the display control unit 103 displays in the display unit 201 an image based on that still image data.

The user performs an operation that indicates the magnification of the still image displayed by the display unit 201. For example, the user indicates the magnification of the still image by performing a pinch-out operation on the display unit 201.

The display control unit 103 calculates the magnification ratio of the still image in accordance with the magnification operation by the user (Step S13). The display control unit 103 encodes the source data (still image data) so as to become a still image in accordance with the calculated magnification ratio (Step S14). The display control unit 103 performs the encoding in a predetermined time interval (for example, a 0.01 sec. time interval) while the magnification operation is being performed by the user. The insertion unit 101 generates one still image data that the display control unit 103 displays in the display unit 201 each time the encoding is performed.

The insertion unit 101 specifies the differential between the data generated by the (n−1)th encoding and the data generated by the nth encoding, which are continuously displayed data, each time encoding is performed (Step S15). For example, with the encoding number being n (initial value n=1), the insertion unit 101 compares the time-series luminance, contrast, gradation, hue, brightness, saturation and the like of the (n−1)th image data generated by the (n−1)th encoding and the nth image data generated by the nth encoding, and specifies a differential on the basis of that comparison result. The insertion unit 101 may compare the luminance, contrast, gradation, hue, brightness, saturation and the like between adjacent pixels of (n−1)th image data and nth image data, and specify a differential on the basis of the comparison result. In the case of the encoding number n being “1”, the 0th image data used by the insertion unit 101 is image data displayed by the display unit 201 prior to the magnification.

The insertion unit 101 may specify the differential of two continuous image data sets as a differential based on any one of luminance, contrast, gradation, hue, brightness, saturation and the like. The insertion portion 101 may specify the differential of two continuous image data sets as a differential based on a combination of any two or more among luminance, contrast, gradation, hue, brightness, saturation and the like. The information that the insertion unit 101 uses when specifying the ditterential of two image data sets is not limited to luminance, contrast, gradation, hue, brightness, and saturation. The insertion unit 101 may use any kind of information provided it is information that can suitably determine the differential of two image data sets.

The insertion unit 101 compares the specified differential and prescribed threshold value. The insertion unit 101 determines whether or not the specified differential is equal to or less than the prescribed threshold value (Step S16).

When the insertion unit 101 determines that the specified differential is equal to or less than the prescribed threshold value (YES in Step S16), it inserts the prescribed image data immediately before the first image data of the two image data sets (Step S17).

Only in the case of the first time of the process of inserting prescribed image data immediately before the first image data of the two image data sets, the insertion unit 101 outputs to the stopping unit 102 a data insertion notification signal indicating that it has inserted the prescribed image data.

The stopping unit 102, upon receiving the data insertion notification signal output from the insertion unit 101, stops the operation of lessening degradation of the display that is performed without being based on the image data after data insertion (Step S18). For example, the stopping unit 102, upon receiving image data after data insertion from the insertion unit 101, stops the refresh operation performed by the display control unit 103.

The display control unit 103 causes the display unit 201 to display the image data after data insertion.

The display unit 201 displays the image (moving image) represented by the image data after data insertion (Step S19a). Then, the display system 1 advances to the process of Step S20.

On the other hand, when the insertion unit 101 has determined that the specified differential is not equal to or less than the prescribed threshold value (NO in Step S16), the display control unit 103 causes the display unit 201 to display encoded image data generated by encoding.

The display unit 201 displays an image represented by the encoded image data (Step S19b). The display system 1 advances to the process of Step S20 without performing the processes of Step S17 to Step S19.

After the process of either Step S19a or Step S19b, the display control unit 103 determines whether or not the magnification operation by the user is completed (Step S20). For example, the display control unit 103 obtains coordinate data indicating positions of the user's fingers from a touch sensor that the display unit 201 includes. When the change in the coordinates indicated by that coordinate data is equal to or less than a predetermined amount, or when there is no information from the touch sensor, the magnification operation of the image by the user is determined to be completed.

In the case of having determined that the magnification operation by the user is not completed (NO in Step S20), the display control unit 103 adds “1” to “n” indicating the encoding number (Step S21). Then the process returns to Step S14.

On the other hand, in the case of the display control unit 103 having determined that the magnification operation by the user is completed (YES in Step S20), the stopping unit 102, upon receiving the data insertion notification signal from the insertion unit 101, resumes the operation of lessening degradation of the display, which is performed without being based on image data after data insertion (Step S22). For example, the stopping unit 102 resumes the refresh operation that is performed by the display control unit 103.

This concludes the description of the process flow of the display system 1 according to the second exemplary embodiment of the present invention.

In the process of the aforementioned display system 1, the insertion unit 101 inserts prescribed image data for lessening degradation of the display, which occurs from display change, in the middle of the source data. The stopping unit 102 stops the operation of lessening degradation of the display occurring from display change which is performed without being based on the image data after data insertion by the insertion unit 101. More specifically, for example the stopping unit 102 stops the refresh operation performed by the display control unit 103, which is performed without being based on the image data after data insertion by the insertion unit 101. The display unit 103 causes the display device 20 to display a magnified image represented by the image data after data insertion.

By this means, in the display unit 201, the display device 20, which performs an operation that lessens degradation of the display that occurs from display change, can cleanly display a display when displaying a display that approximates a still image in image data which, at the time of a magnification operation by the user, changes at high speed.

The process of the display system 1 is not limited to the process shown in FIG. 6. A portion of the process shown in FIG. 6 (steps S15 to S17) may be the following process, that is, the insertion unit 101 compares the differential between an (n−1)th image data and an nth image data, and a prescribed threshold value (“n” indicating the encoding number). Also, the insertion unit 101 compares the differential between an nth image data and an (n+1)th image data, and a prescribed threshold value. In the case of having judged that the differential between the (n−1)th image data and the nth image data is not equal to or less than the prescribed threshold value, and that the differential between the nth image data and the (n+1)th image data is equal to or less than the prescribed threshold value, the insertion unit 101 inserts a prescribed image data immediately before the nth image data (that is, immediately after the (n−1)th image data).

Note that when a typical image system displays an image, the image system outputs image information of a plurality of images to the display unit in the period of 1 second. For that reason, a typical image system performs numerous refresh operations in the period of 1 second, leading to the frequent display of monochromatic images between moving images. Also, in a typical image display system, the processing speed drops due to the frequent performance of the refresh operation.

In contrast, the display control unit 103 provided in the display system 1 according to the exemplary embodiments of the present invention stops the refresh operation. The insertion unit 101 provided in the display system 1 generates image data that produces a similar effect to the refresh operation, and inserts it in image data.

For that reason, the display system 1 can perform the process at a speed equivalent to displaying ordinary image data without performing a refresh operation.

The storage unit 30 in the exemplary embodiments of the present invention may be provided anywhere in the range in which suitable information transmission and reception is performed. Also, a plurality of storage units 30 may exist in the range in which suitable information transmission and reception is performed, and the plurality of storage units 30 may store data in a dispersed manner.

The order of processes in the process flow in the exemplary embodiments of the present invention may be interchanged in the range in which suitable processing is performed.

While the exemplary embodiments of the present invention have been described, the aforementioned display system 1, the display control device 10, and the display device 20 may internally have a computer system. The process of each process described above may be stored in a computer-readable recording medium in the form of a program, and by the computer reading and executing this program, the aforementioned processes may be performed. A computer-readable recording medium may be a magnetic disk, an optical-magnetic disk, a CD-ROM, a DVD-ROM, a semiconductor memory, and the like. Also, this computer program may be distributed to computers over communication lines, and a computer that has received this distribution may be made to execute that program.

The aforementioned program may be a program for implementing some of the above functions.

Moreover, the aforementioned program may be a so-called differential file (differential program), whereby the functions described above can be realized by a combination with programs that are already recorded in the computer system.

While the several exemplary embodiments of the present invention has been described, the aforementioned exemplary embodiments are presented as examples and do not serve to limit the scope of the present invention. Various omissions, replacements and changes can be made in a scope that does not depart from the gist of the invention.

This application is based upon and claims the benefit of priority from Japanese patent application No. 2014-191435, filed on Sep. 19, 2014, the disclosure of which is incorporated herein in its entirety by reference.

### INDUSTRIAL APPLICABILITY

The present invention may be applied to a display system, a display control device, a display control method, and a program.

### REFERENCE SYMBOLS

10: Display control device
20: Display device
30: Storage unit
101: Image data insertion unit (insertion unit)
102: Display improvement operation stopping unit (stopping unit)
103: Display control unit
201: Display unit

1. A display system comprising:
a display control device that inserts prescribed image data for lessening degradation of image quality in source data to generate post-insertion image data; and
a display device that displays an image based on the post-insertion image data.

2. The display system according to claim 1, wherein the display device performs an improvement operation for lessening degradation of image quality that arises by changing an image displayed in the display device.

3. The display system according to claim 1, wherein the display control device stops the improvement operation, the improvement operation being different from an operation of displaying an image generated based on the prescribed image data.

4. The display system according to claim 2, wherein the improvement operation is a refresh operation that once darkens an entire display screen of the display device.

5. The display system according to claim 1, wherein
the source data includes first image data and second image data that are continuous with each other,
the display control device determines whether a differential between the first image data and the second image data is equal to or less than a prescribed threshold value, and
the display control device inserts the prescribed image data immediately before the first data in a case of having determined the differential to be equal to or less than the prescribed threshold value.

6. The display system according to claim 5, wherein the differential includes a time-series differential between the first image data and the second image data.

7. The display system according to claim 5, wherein the differential includes a differential between a differential between data displayed in adjacent pixels included in the first image data and a differential between data displayed in adjacent pixels included in the second image data.

8. The display system according to claim 5, wherein the differential includes a differential between luminance of the first image data and luminance of the second image data.

9. The display system according to claim 5, wherein the differential includes a differential between contrast of the first image data and contrast of the second image data.

10. The display system according to claim 5, wherein the differential includes a differential between gradation of the first image data and gradation of the second image data.

11. The display system according to claim 5, wherein the differential includes a differential between hue of the first image data and hue of the second image data.

12. The display system according to claim 5, wherein the differential includes a differential between brightness of the first image data and brightness of the second image data.

13. The display system according to claim 5, wherein the differential includes a differential between saturation of the first image data and saturation of the second image data.

14. The display system according to claim 1, wherein
the source data includes two image data that are continuous with each other in time series,
the display control device inserts the prescribed image data between the two image data,
the display device displays an image generated based on the prescribed image data after displaying an image generated based on one of the two image data, and
the display device displays an image generated based on the other of the two image data sets after displaying the image generated based on the prescribed image data.

15. The display system according to claim 1, wherein
the source data includes a first image data, a second image data, and a third image data that are continuous with each other in time series,
the display control device determines whether a differential between the first image data and the second image data is equal to or less than the prescribed threshold value,
the display control device determines whether a differential between the second image data and the third image data is equal to or less than the prescribed threshold value, and
the display control device inserts the prescribed image data between the first image data and the second image data, in the case of having determined the differential between the first image data and the second image data to not be equal to or less than the prescribed threshold value, and the differential between the second image data and the third image data to be equal to or less than the prescribed threshold value.

16. A display control device comprising:
an insertion unit that inserts prescribed image data for lessening degradation of a display in source data.

17. The display control device according to claim 16, further comprising:
a stopping unit that stops an improvement operation for lessening degradation of image quality that arises by changing an image, the improvement operation being different from an operation of displaying an image generated based on the prescribed image data.

18. A display control method comprising:
inserting prescribed image data for lessening degradation of image quality in source data.

19. The display control method according to claim 18, further comprising:
stopping an improvement operation for lessening degradation of image quality that arises by changing an image, the improvement operation being different from an operation of displaying an image generated based on the prescribed image data.

20.-21. (canceled)
